(19) United States
(12) Patent Application Publication
(10) Pub. No.: US 2008/0145692 A1
(43) Pub. Date: Jun. 19, 2008

(54) MAGNETIC PULSE-ASSISTED CASTING OF METAL ALLOYS & METAL ALLOYS PRODUCED THEREBY

(75) Inventor: Abdelouahab ZIANI, Chandler, AZ (US)

Correspondence Address: MCDERMOTT WILL & EMERY LLP, 18191 VON KARMAN AVE., SUITE 500, IRVINE, CA, 92612-7108, US

(73) Assignee: HERAEUS INC., Chandler, AZ (US)

(21) Appl. No.: 11/950,197

(22) Filed: Dec. 4, 2007

Related U.S. Application Data
(60) Provisional application No. 60/872,937, filed on Dec. 4, 2006.

(51) Int. Cl. H01F 1/04; B29C 35/08

(52) U.S. Cl. 428/611; 427/598

(57) ABSTRACT

A method of forming a cast metal alloy comprises providing a molten ferromagnetic metal alloy; utilizing AC or DC electrical power to generate a pulsed or oscillating magnetic field within the interior space of a casting mold via a magnetic core assembly surrounding the casting mold; filling the casting mold with the molten metal alloy; applying the pulsed or oscillating magnetic field to the molten metal alloy during solidification to mix a molten portion of the solidifying body; and continuing applying the pulsed or oscillating magnetic field to the solidifying body until complete solidification is achieved. The method has particular utility in the formation of cast ferromagnetic alloys for use as high PTF sputtering targets having improved microstructural features.

### CROSS-REFERENCE TO PROVISIONAL APPLICATION

This application claims priority from U.S. provisional patent application Ser. No. 60/872,937 filed Dec. 4, 2006, the entire disclosure of which is incorporated herein by reference.

### FIELD OF THE DISCLOSURE

The present disclosure relates generally to a novel casting process for forming improved metal alloys with desirable microstructures, and improved chemical homogeneity and ductility. The present disclosure enjoys particular utility in the formation of deposition sources, e.g., high pass-through flux (PTF) sputtering targets comprising ferromagnetic metal alloy materials, utilized in the manufacture of magnetic and magneto-optical (MO) recording media.

### BACKGROUND OF THE DISCLOSURE

Deposition sources, e.g., sputtering targets, are widely utilized in a variety of manufacturing technologies for forming thin films of metals, metal alloys, semiconductors, ceramics, dielectrics, ferroelectrics, and cermets. In a sputtering process, the material source, i.e., the sputtering target, is bombarded with ions from a plasma, which ions dislodge or eject atoms or molecules from the surface of the sputtering target, which ejected atoms or molecules are deposited atop a substrate to form a thin film coating. Sputter deposition technology is extensively utilized in the manufacture of thin film data/information storage and retrieval media, e.g., magnetic and magneto-optical (MO) media for depositing underlayers, interlayers, magnetic layers, dielectrics, and protective overcoat layers. In the manufacture of sputtering targets utilized for such deposition processing, it is desirable to produce sputtering targets that provide uniform thin films, minimal particle generation during sputtering, and desired properties. High density and low porosity sputtering target materials are considered essential for avoiding or at least minimizing deleterious particle generation during sputtering.

Many metal alloys utilized in the manufacture of sputtering targets, e.g., ferromagnetic alloys utilized for forming soft magnetic underlayers (SULs) and magnetically hard recording layers of magnetic recording media, typically exhibit a columnar dendritic-type microstructure upon solidification. Thermo-mechanical processing of ingots of alloys with such as-cast microstructure present a number of challenges for achieving a crack-free workpiece of desirable form factor after cold or hot working. Further, the columnar growth inherent to casting in metallic or graphite-based molds results in unfavorable grain textures with respect to easy magnetization along magnetization preferred orientations, the latter being the main factor in determining the pass-through flux (PTF) characteristic of magnetically assisted sputtering targets, e.g., magnetron targets. In addition, large size casting of magnetic alloys tends to produce chemically inhomogeneous ingots as a result of solute segregation during solidification. As a consequence, castings of multi-component sputtering target materials are generally limited to small form factors in order to minimize the extent of chemical segregation during solidification, a practice which in turn negatively impacts productivity, yield, and lot-to-lot reproducibility.

Further, many ferromagnetic alloys utilized in the manufacture of sputtering targets for the manufacture of thin film magnetic and magneto-optical (MO) recording media, particularly boron (B)-containing Co, Fe, and Ni based alloys and those containing a refractory or rare earth metal element, exhibit deep eutectic and peritectic reactions and are inherently brittle in their as-cast condition. Despite efforts at refinement of as-cast microstructures via appropriate mold designs and supplemental external mold cooling, the resultant alloys still suffer from lack of ductility and chemical homogeneity. The nucleation and growth of dendrites during solidification imposed by heat extraction, primarily via thermal conduction, is largely determined by heat flux direction and thermal gradients during conventional casting.

In view of the foregoing, there exists a clear need for improved methodology for manufacturing improved sputtering target materials with desirable microstructures, and improved chemical homogeneity and ductility. In particular, there exists a clear need for improved metal alloy materials useful in the formation of deposition sources, e.g., high pass-through flux (PTF) sputtering targets comprising ferromagnetic metal alloy materials, utilized in the manufacture of magnetic and magneto-optical (MO) recording media.

### SUMMARY OF THE DISCLOSURE

An advantage of the present disclosure is improved methodology for forming cast ferromagnetic metal alloys.

Another advantage of the present disclosure is improved cast ferromagnetic metal alloys.

Additional advantages and other features of the present disclosure will be set forth in the description which follows and in part will become apparent to those having ordinary skill in the art upon examination of the following or may be learned from the practice of the present disclosure. The advantages of the present disclosure may be realized and obtained as particularly pointed out in the appended claims.

According to an aspect of the present disclosure, the foregoing and other advantages are obtained in part by an improved method of forming a cast ferromagnetic metal alloy, comprising applying a pulsed or oscillating magnetic field to a molten ferromagnetic metal alloy material during solidification thereof, the molten ferromagnetic metal alloy material selected from the group consisting of: (1) Co-based (CoX) alloys, where X is at least one element selected from the group consisting of: Au, B, Ce, Cr, Cu, Dy, Er, Fe, Gd, Hf, Ho, La, Lu, Ni, Nb, Nd, P, Pt, Sc, Sm, Ta, Tb, Y, Zn, and Zr; (2) Fe-based (FeX) alloys, where X is at least one element selected from the group consisting of: Au, B, Ce, Co, Cr, Cu, Dy, Er, Gd, La, Lu, Nb, Nd, P, Pr, Pt, Sc, Sm, Ta, Tb, Th, Y, and Zr; and (3) Ni-based (NiX) alloys, where X is at least one element selected from the group consisting of: Au, B, Ce, Co, Cr, Cu, Dy, Er, Fe, Gd, Hf, La, Nd, Ni, P, Pt, Pr, Sc, Y, Yb, and Zr.

According to embodiments of the present disclosure, the method comprises comprising steps of:

(a) providing the molten metal alloy material;

(b) utilizing DC or AC electrical power to generate a pulsed or oscillating magnetic field within the interior space of a casting mold via a magnetic core assembly surrounding the casting mold;

(c) at least partially filling the casting mold with the molten metal alloy material;

(d) applying the pulsed or oscillating magnetic field to the molten metal alloy material during solidification thereof to agitate a molten portion of a solidifying body of the metal alloy material; and

(e) continuing applying the pulsed or oscillating magnetic field to the solidifying body until solidification is complete.

In the above process, step (d) comprises inducing eddy currents within the solidifying body comprising molten and solid portions, and interacting the induced eddy currents with the applied magnetic field to produce a pulsed or oscillating Lorentz force field within the solidifying body which mixes the molten portion of the solidifying body as solidification progresses.

Preferably, steps (a)-(e) produce a cast metal alloy comprising primary spheroids, wherein the primary spheroids have an aspect ratio on the order of 0.9, and the cast metal alloy comprises discontinuous eutectic domain boundaries comprising about 10⁻³ or less connecting lamellae/μm.

Another aspect of the present disclosure is an improved cast ferromagnetic metal alloy comprising primary spheroids, comprising a ferromagnetic metal material selected from the group consisting of: (1) Co-based (CoX) materials, where X is at least one element selected from the group consisting of: Au, B, Ce, Cr, Cu, Dy, Er, Fe, Gd, Hf, Ho, La, Lu, Ni, Nb, Nd, P, Pt, Sc, Sm, Ta, Tb, Y, Zn, and Zr; (2) Fe-based (FeX) materials, where X is at least one element selected from the group consisting of: Au, B, Ce, Co, Cr, Cu, Dy, Er, Gd, La, Lu, Nb, Nd, P, Pr, Pt, Sc, Sm, Ta, Tb, Th, Y, and Zr; and (3) Ni-based (NiX) materials, where X is at least one element selected from the group consisting of: Au, B, Ce, Co, Cr, Cu, Dy, Er, Fe, Gd, Hf, La, Nd, Ni, P, Pt, Pr, Sc, Y, Yb, and Zr, wherein the primary spheroids have an aspect ratio on the order of 0.9, and the alloy comprises discontinuous eutectic domain boundaries comprising 10⁻³ or less connecting lamellae/μm.

Additional advantages and aspects of the present disclosure will become readily apparent to those skilled in the art from the following detailed description, wherein embodiments of the present disclosure are shown and described, simply by way of illustration of the best mode contemplated for practicing the present disclosure. As will be described, the present disclosure is capable of other and different embodiments, and its several details are susceptible of modification in various obvious respects, all without departing from the spirit of the present disclosure. Accordingly, the drawing and description are to be regarded as illustrative in nature, and not as limitative.

### BRIEF DESCRIPTION OF THE DRAWINGS

The following detailed description of the embodiments of the present disclosure can best be understood when read in conjunction with the following drawings, in which:

FIG. 1 is a schematic representation of an illustrative, but non-limitative, embodiment of an apparatus suitable for performing in-situ magnetic pulsing of a casting mold containing a metal alloy according to an embodiment of the present disclosure;

FIG. 2 is a simulated representation of magnetic flux line leakage of an electromagnetic coil interacting with a casting mold containing a metal alloy, according to an illustrative, but non-limitative embodiment according to the present disclosure, as generated by a 3-phase, 6-pole AC power source;

FIG. 3 is a graph illustrating the magnetic flux density profiles at 160 A at 10 Hz when currents in both cores flow in the same direction (upper curve) and in opposite directions (lower curve);

FIG. 4 shows micrographs illustrating the microstructural features of a cast CoCrPtB ferromagnetic alloy formed by a magnetic pulse-assisted casting process according to the present disclosure;

FIG. 5 shows micrographs illustrating the microstructural features of a cast CoCrPtB ferromagnetic alloy formed by conventional casting and hot working;

FIG. 6 shows micrographs illustrating the microstructural features of a cast CoCrPtBCu ferromagnetic alloy formed by a magnetic pulse-assisted casting process according to the present disclosure; and

FIG. 7 shows micrographs illustrating the microstructural features of a cast CoCrPtBCu ferromagnetic alloy formed in a rectangular graphite mold in conventional manner; and

FIG. 8 is a schematic representation of a spheroid (left half) and an equiaxed dendrite (right half) for illustrating the dimensional features defining aspect ratios according to the present disclosure.

### DETAILED DESCRIPTION OF THE DISCLOSURE

The present disclosure is based upon the discovery that efficient, cost-effective formation of improved cast ferromagnetic metal alloys, suitable for use in the manufacture of high quality metal alloy sputtering targets exhibiting high PTF values, is facilitated by modifying the as-cast microstructure in order to produce a fully equiaxed structure comprising a spheroidal-like primary phase. In addition, the present disclosure is based upon discovery that magnetic pulse-assisted casting of ferromagnetic alloys significantly improves homogeneity throughout the entirety of the ingot and reduces solidification-induced microporosity of the solidified (i.e., cast) material.

Briefly stated, magnetic pulse-assisted casting of ferromagnetic metal alloys according to the present disclosure comprises:
utilizing AC or pulsed DC electrical power to generate an oscillating or pulsed magnetic field with magnetic core members surrounding a casting mold containing a solidifying body of ferromagnetic metal alloy material therein;
inducing eddy currents of proportional frequency and waveform within the solidifying body comprising molten and solid portions;
interacting the induced eddy currents with the applied magnetic field to produce a pulsed Lorentz force field within the solidifying body which mixes the molten portion of the solidifying body as solidification progresses.

According to the methodology afforded by the present disclosure, the mixing of the solidifying body prevents the development of bulk thermal gradients during solidification, a condition considered necessary for promotion of homogeneous nucleation resulting in equiaxed growth. In addition, the agitation of the partially solidified (or semi-liquid) metal alloy material disrupts columnar growth which yields elongated dendrites having unfavorable crystalline orientations. Consequently, homogeneously composed nuclei of the primary phase form isolated crystallites in the agitated molten alloy portion (or pool) and subsequently grow into primary spheroids having an aspect ratio (see below) on the order of 0.9, and the alloy comprises discontinuous eutectic domain boundaries comprising 10⁻³ or less connecting lamellae/μm.

Advantageously, the thus-formed spheroid-like primary phase crystals are stronger and more ductile than elongated crystals of conventionally cast ferromagnetic metal alloy materials in terms of stress distribution at their interfaces. Further, ferromagnetic metal alloy materials exhibiting such microstructure clearly have less interfacial area at the interfaces of the primary phase crystal's interfaces, resulting in a decrease of interfacial energy, more significantly in the case of an incoherent interface. In turn, the reduction of the interfacial energy advantageously inhibits crack initiation and propagation.

In addition to the above advantageous features of the presently disclosed magnetic pulse-assisted casting process, the continuous mixing of the partially solidified alloy melt facilitates re-homogenization of the ingot's chemical composition via a mass transport mechanism, and the recirculation of the molten phase contributes to elimination of ingot porosity. Finally, magnetic pulsing of the remaining eutectic liquid advantageously produces a discontinuous and markedly refined lamellar eutectic structure.

Magnetic pulse-assisted casting of ferromagnetic metal alloy materials according to the present disclosure is particularly well-suited for those alloy systems in which eutectic and peritectic reactions occur and/or those alloys exhibiting a wide solidification temperature range. The magnetic pulse-assisted methodology according to the present disclosure is particularly useful for casting a wide range of ferromagnetic metal alloy materials, including, for example, but not by way of limitation, binary, ternary, quaternary, and higher multi-component ferromagnetic alloy materials typically utilized in the formation of thin film layers of magnetic and/or magneto-optical (MO) recording media employing sputter deposition techniques. Such multi-component ferromagnetic alloy materials include, for example:
Co-based (CoX) alloys, where X is at least one element selected from the group consisting of: Au, B, Ce, Cr, Cu, Dy, Er, Fe, Gd, Hf, Ho, La, Lu, Ni, Nb, Nd, P, Pt, Sc, Sm, Ta, Tb, Y, Zn, and Zr;
Fe-based (FeX) alloys, where X is at least one element selected from the group consisting of: Au, B, Ce, Co, Cr, Cu, Dy, Er, Gd, La, Lu, Nb, Nd, P, Pr, Pt, Sc, Sm, Ta, Tb, Th, Y, and Zr; and
Ni-based (NiX) alloys, where X is at least one element selected from the group consisting of: Au, B, Ce, Co, Cr, Cu, Dy, Er, Fe, Gd, Hf, La, Nd, Ni, P, Pt, Pr, Sc, Y, Yb, and Zr.

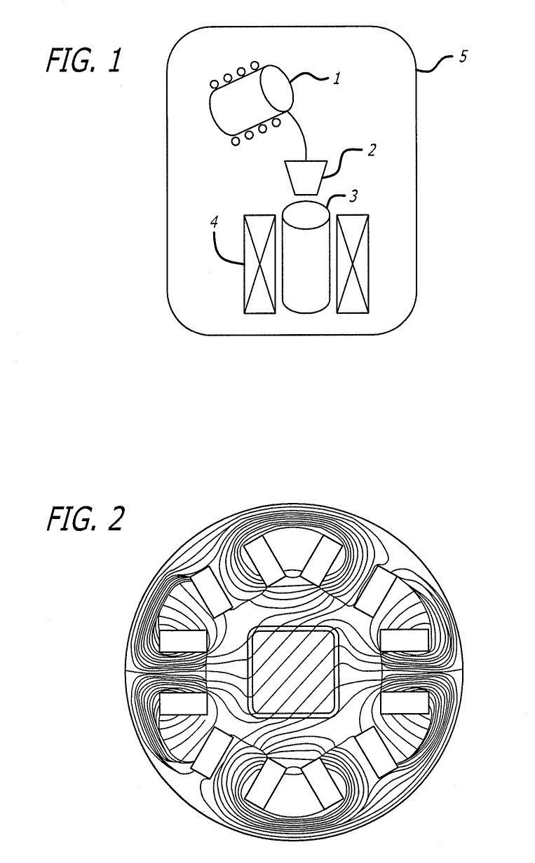

Referring to FIG. 1, shown therein is a schematic representation of an illustrative, but non-limitative, embodiment of an apparatus suitable for performing in-situ magnetic pulsing of a casting mold containing a ferromagnetic metal alloy according to an embodiment of the present disclosure, wherein: reference numeral 1 indicates a heated crucible (for example, inductively or resistance heated) containing a molten metal alloy material, e.g., a CoX, FeX, or NiX alloy material such as enumerated above; reference numeral 2 indicates a tundish; reference numeral 3 indicates a casting mold comprised of appropriately inert material(s); reference numeral 4 indicates at least one electromagnetic coil; and reference numeral 5 indicates a suitable enclosure, e.g., a vacuum chamber.

According to a preferred embodiment of the present disclosure, one or more water cooled electromagnetic coils 4 are confined in a stainless steel enclosure 5 surrounding a cylindrically or rectangularly shaped casting mold 3. The electromagnetic coil(s) 4 is (are) connected to a 3-phase, 6-pole AC power source or a pulsed DC power source (not shown in FIG. 1 for illustrative simplicity) capable of generating an oscillating current of variable intensity at a predetermined wave frequency. An instantaneous simulated image of the spatial distribution of the magnetic flux lines emanating at the vicinity of the coil(s) is shown in FIG. 2, wherefrom it is apparent that magnetic flux lines from the coils interact with the casting mold 3 such that a plurality of generally parallel magnetic flux lines pass through the alloy melt contained in casting mold 3 and induce eddy currents within the solidifying body (melt) of alloy material contained therein.

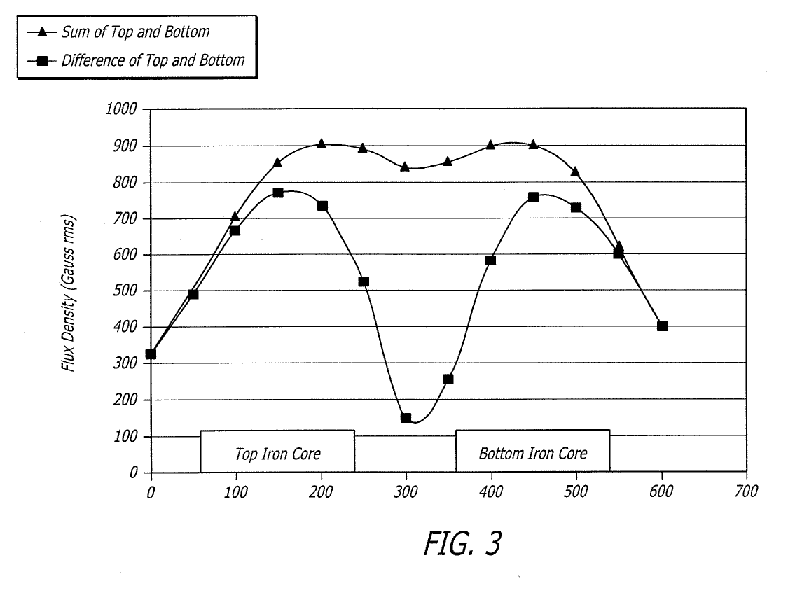

In more detail, and as seen in FIG. 1, alloy material contained in crucible 1 is melted, for example by resistive heating, and poured via tundish 2 into mold 3 surrounded by electromagnetic coil assembly 4. Mold 3 is made of an appropriate material, e.g., ceramic, graphite, or water cooled metal material. Prior to pouring of the molten metal alloy material into mold 3, the AC or DC power supply to the electromagnetic coils assembly is activated and set at a predetermined current level and frequency or pulse rate/duration. The magnetic field leaking into the solidifying molten alloy pool in mold 3 creates eddy currents within the alloy pool which in turn generate an oscillating Lorentz force field of adjustable intensity. The resulting maximum intensity of the magnetic field is shown in FIG. 3, which is a graph illustrating the magnetic flux density profiles at 160 A at 10 Hz in the case of 2 magnetic cores with currents flowing in the same direction (upper curve) and in opposite directions (lower curve).

According to the present disclosure, magnetically induced agitation of the pool of metal alloy material in mold 3 as it solidifies promotes the development of particular microstructural features within the solidified (i.e., cast) alloy. Examples of cast ferromagnetic alloy microstructures induced by the magnetic pulsing are described below and compared with alloy microstructures of compositionally equivalent alloys formed via conventional casting techniques.

### EXAMPLE I

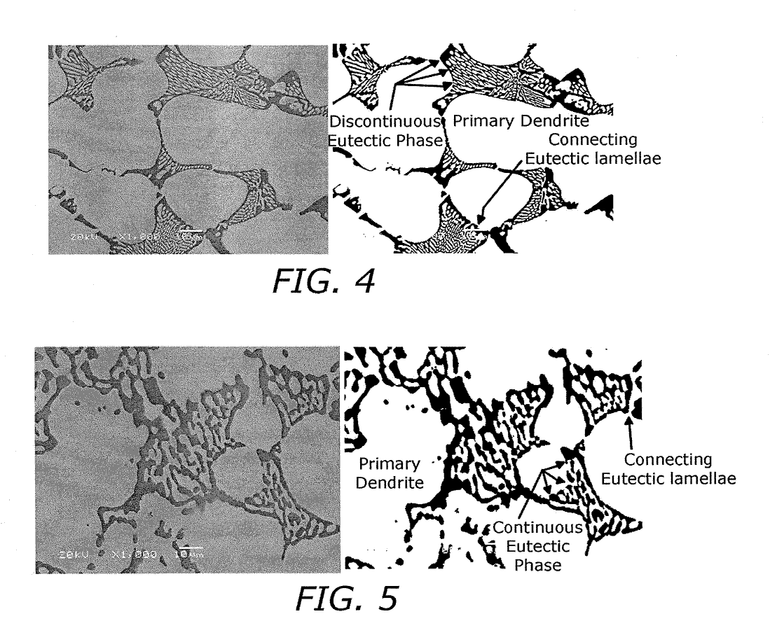

A CoCrPtB alloy was inductive power melted under a 10⁻³ Torr vacuum and heated in crucible 1 to about 1450° C., which temperature represents an about 50° C. superheating above the liquidus temperature of the alloy. Prior to pouring the molten alloy from crucible 1 into casting mold 3 via tundish 2, AC power was supplied to electromagnetic coils 4 surrounding the casting mold 3 at a current of about 130 A and oscillation frequency of about 10 Hz. The molten alloy was then poured into casting mold 3 to a depth of about 10 in. Magnetically induced mixing of the solidifying alloy within the casting mold was sustained until complete solidification was achieved, i.e., about 47 sec. During this interval, the mixing proceeded as the fraction of solids within the melt increased to a point where the viscosity of the material was such that the resulting inertia prevented any further mixing. In this instance, the point at which inertia prevented further mixing coincided with completion of growth of primary dendrites, as seen in FIG. 4, which shows micrographs illustrating the microstructural features of a cast CoCrPtB ferromagnetic alloy formed by the magnetic pulse-assisted casting process according to the present disclosure. For comparison purposes, FIG. 5 shows micrographs illustrating the microstructural features of a cast CoCrPtB ferromagnetic alloy formed by conventional casting and hot working.

As is evident from a comparison of the photomicrographs of FIGS. 4 and 5, magnetic pulse-assisted casting of the CoCrPtB alloy according to the present disclosure enables development of finer and discontinuous eutectic domain boundaries. The degree of discontinuity of the eutectic domain boundaries is measurable by the number of connecting eutectic lamellae into a primary dendrite. This is accomplished quantitatively by measuring the number of connecting eutectic lamellae per unit length of the eutectic domain boundary. In the case of the CoCrPtB alloy made according to the magnetic pulse-assisted casting methodology of the present disclosure and shown in the photomicrograph of FIG. 4, this amounts to about 7×10⁻⁴ connecting lamellae/μm; whereas, in the case of the CoCrPtB alloy made by conventional casting methodology and shown in the photomicrographs of FIG. 5, the number of connecting eutectic lamellae per unit length of the eutectic domain boundary is estimated to be about 10⁻² connecting lamellae/μm. In addition to the improvement in number of connecting eutectic lamellae per unit length of the eutectic domain boundary, the instant pulse-assisted casting methodology affords another advantage vis-à-vis conventional casting methodology in that a significant improvement in refinement of the eutectic domains is observed, resulting from the continuous mixing of the remaining liquid portion of the solidifying melt and shearing of the primary dendrites which tend to smooth the contours of the latter.

### EXAMPLE II

In the previous example, the alloy composition was such that a large volume fraction of the primary phase was developed, whereas the amount of eutectic domains was limited to a minor fraction. In this example, however, a CoCrPtBCu alloy was utilized which formed a substantially greater volume fraction of eutectic domains. The CoCrPtBCu alloy was inductive power melted under a 10⁻³ Torr vacuum and heated in crucible 1 to about 1400° C., which temperature represents an about 40° C. superheating above the liquidus temperature of the alloy. Prior to pouring the molten alloy from crucible 1 into casting mold 3 via tundish 2, AC power was supplied to electromagnetic coils 4 surrounding the casting mold 3 at a current of about 150 A and oscillation frequency of about 10 Hz. The molten alloy was then poured into casting mold 3 to a depth of about 10 in. The mixing of the liquid portion of the solidifying melt induced by the magnetic pulsing in the presence of a large volume fraction of eutectic liquid effectively disrupted dendrite growth and enabled development of a particular dendritic feature referred to as “primary spheroids”.

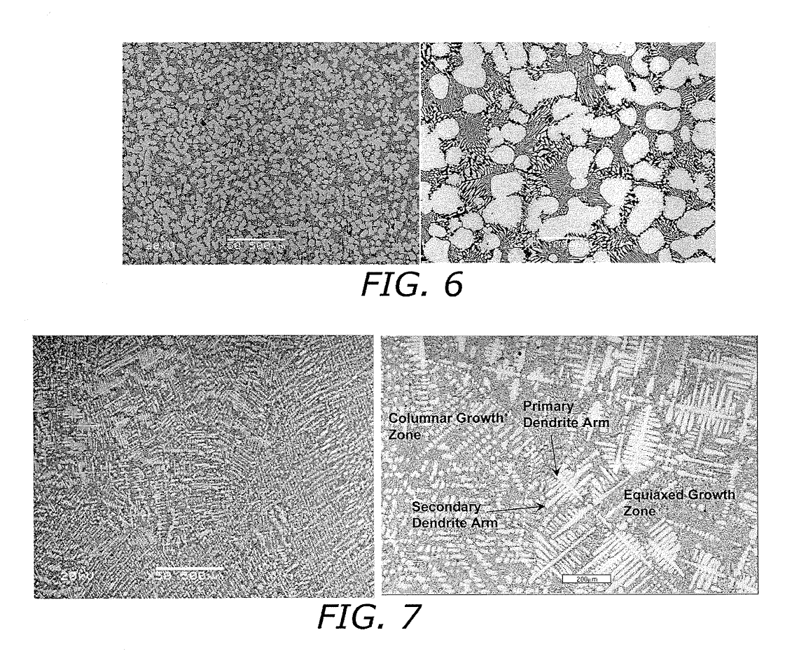

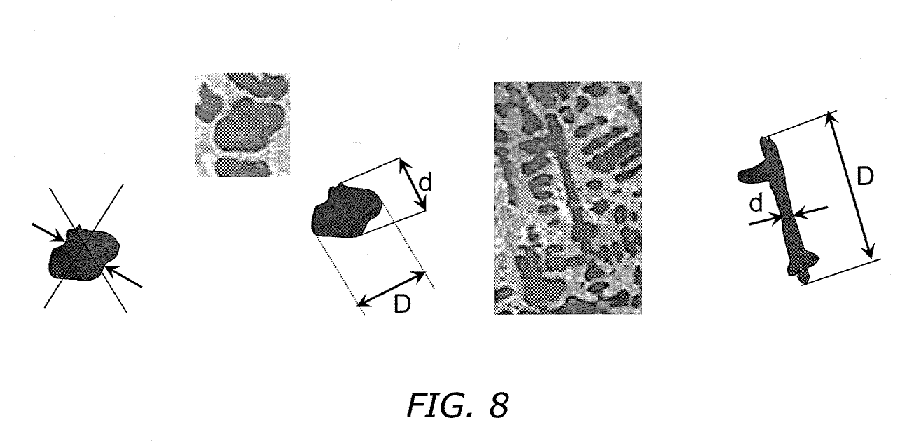

A typical microstructure obtained by magnetic pulse-assisted casting of this alloy family is shown in the micrographs of FIG. 6 illustrating the microstructural features of a CoCrPtBCu ferromagnetic alloy formed by a magnetic pulse-assisted casting process according to the present disclosure. For comparison purposes, FIG. 7 shows micrographs illustrating the microstructural features of a CoCrPtBCu ferromagnetic alloy cast in a rectangular graphite mold in conventional manner. In either figure, the left half view shows the microstructural features of the resultant cast CoCrPtBCu alloys at lower magnification, whereas, the right half view shows the microstructural features of the resultant cast CoCrPtBCu alloys at higher magnification.

As is evident from the lower magnification view of FIG. 7, dendrite growth of the conventionally cast alloy is not uniform and undergoes a transition from a columnar-type growth (right side of micrograph) into an equiaxed-type growth (left side of micrograph). By contrast, this non-uniform growth pattern is not observed in the micrographs of FIG. 6 for a compositionally equivalent alloy formed by magnetic pulse-assisted casting according to the present disclosure.

Another aspect distinguishing the alloys formed by magnetic pulse-assisted casting and by conventional casting is revealed in the morphology of the primary spheroidal phase. For example, an equiaxed dendrite typically exhibits a primary arm to which secondary arms are attached. In such instances, an aspect ratio may be defined for both spheroids and equiaxed dendrites.

Referring to FIG. 8, shown therein is a schematic representation of a spheroid (left half) and an equiaxed dendrite (right half) for illustrating the dimensional features defining aspect ratios according to the present disclosure. For the spheroid, the aspect ratio is defined as the ratio of the smallest dimension (d) as determined based upon the shortest distance between two concave surfaces delimiting the spheroid and its major length (D); whereas, for the equiaxed dendrite the aspect ratio is defined as the ratio of the primary dendrite width (d) and its length (D). This leads to an aspect ratio of about 0.9 for the spheroid and an aspect ratio of about 0.1 for the equiaxed dendrite.

According to the present disclosure, mixing and re-circulation of the liquid portion of the solidifying body of alloy material prevents the development of bulk thermal gradients during solidification, which bulk thermal gradient condition is considered necessary for promotion of homogeneous nucleation resulting in equiaxed growth. In addition, the mixing of the partially solidified (or semi-liquid) metal alloy material disrupts inhomogeneous growth which yields columnar and/or coarse equiaxed dendrites having unfavorable crystalline orientations and aspect ratios (as defined above) on the order of about 0.1. Consequently, homogeneously composed nuclei of the primary phase form isolated crystallites in the stirred molten alloy portion (or pool) and subsequently grow into primary spheroids having aspect ratios (as defined above) on the order of about 0.9.

Advantageously, the primary spheroids formed by magnetic pulse-assisted casting according to the present disclosure are stronger and more ductile than elongated crystals of conventionally cast ferromagnetic metal alloy materials in terms of stress distribution at their interfaces. Further, ferromagnetic metal alloy materials exhibiting such microstructure clearly have less interfacial area at the interfaces of the primary phase crystal's interfaces, resulting in a decrease of interfacial energy, more significantly in the case of an incoherent interface. In turn, the reduction of the interfacial energy advantageously inhibits crack initiation and propagation. Finally, ferromagnetic metal alloys produced by the instant methodology are less porous and facilitate fabrication of sputtering targets having greater pass-through flux (PTF) than compositionally equivalent targets produced via conventional casting.

In summary, the magnetic pulse-assisted casting methodology of the present disclosure affords a number of significant advantages vis-à-vis conventional casting techniques for the manufacture of alloys, particularly ferromagnetic alloy materials utilized in the fabrication of sputtering targets, including increased ductility, reduced porosity, improved microstructure, increased PTF, and cost-effective processing.

In the previous description, numerous specific details are set forth, such as specific materials, structures, processes, etc., in order to provide a better understanding of the present invention. However, the present invention, can be practiced without resorting to the details specifically set forth herein. In other instances, well-known processing techniques and structures have not been described in order not to unnecessarily obscure the present invention.

Only the preferred embodiments of the present invention and but a few examples of its versatility are shown and described in the present disclosure. It is to be understood that the present invention is capable of use in various other combinations and environments and is susceptible of changes and/or modifications within the scope of the inventive concept as expressed herein.

What is claimed is:

1. A method of forming a cast ferromagnetic metal alloy, comprising applying a pulsed or oscillating magnetic field to a molten ferromagnetic metal alloy material during solidification thereof, said molten ferromagnetic metal alloy material selected from the group consisting of:
Co-based (CoX) alloys, where X is at least one element selected from the group consisting of: Au, B, Ce, Cr, Cu, Dy, Er, Fe, Gd, Hf, Ho, La, Lu, Ni, Nb, Nd, P, Pt, Sc, Sm, Ta, Tb, Y, Zn, and Zr;
Fe-based (FeX) alloys, where X is at least one element selected from the group consisting of: Au, B, Ce, Co, Cr, Cu, Dy, Er, Gd, La, Lu, Nb, Nd, P, Pr, Pt, Sc, Sm, Ta, Tb, Th, Y, and Zr; and
Ni-based (NiX) alloys, where X is at least one element selected from the group consisting of: Au, B, Ce, Co, Cr, Cu, Dy, Er, Fe, Gd, Hf, La, Nd, Ni, P, Pt, Pr, Sc, Y, Yb, and Zr.

2. The method according to claim 1, comprising steps of:
(a) providing a said molten ferromagnetic metal alloy material;
(b) utilizing DC or AC electrical power to generate a pulsed or oscillating magnetic field within the interior space of a casting mold via a magnetic core assembly surrounding said casting mold;
(c) at least partially filling said casting mold with said molten metal alloy material;
(d) applying said pulsed or oscillating magnetic field to said molten metal alloy material during solidification thereof to mix a molten portion of a solidifying body of said metal alloy material; and
(e) continuing applying said pulsed or oscillating magnetic field to said solidifying body until solidification is complete.

3. The method according to claim 2, wherein step (d) comprises inducing eddy currents within said solidifying body comprising molten and solid portions, and interacting said induced eddy currents with the applied magnetic field to produce a pulsed or oscillating Lorentz force field within said solidifying body which mixes the molten portion of the solidifying body as solidification progresses.

4. The method according to claim 2, wherein steps (a)-(e) produce a cast metal alloy comprising primary spheroids.

5. The method according to claim 4, wherein said primary spheroids have an aspect ratio on the order of 0.9.

6. The method according claim 4, wherein said cast metal alloy comprises discontinuous eutectic domain boundaries.

7. The method according to claim 6, wherein said discontinuous eutectic domain boundaries comprise about 10⁻³ or less connecting lamellae/μm.

8. A cast ferromagnetic metal alloy comprising primary spheroids, comprising a ferromagnetic metal material selected from the group consisting of:
Co-based (CoX) materials, where X is at least one element selected from the group consisting of: Au, B, Ce, Cr, Cu, Dy, Er, Fe, Gd, Hf, Ho, La, Lu, Ni, Nb, Nd, P, Pt, Sc, Sm, Ta, Tb, Y, Zn, and Zr;
Fe-based (FeX) materials, where X is at least one element selected from the group consisting of: Au, B, Ce, Co, Cr, Cu, Dy, Er, Gd, La, Lu, Nb, Nd, P, Pr, Pt, Sc, Sm, Ta, Tb, Th, Y, and Zr; and
Ni-based (NiX) materials, where X is at least one element selected from the group consisting of: Au, B, Ce, Co, Cr, Cu, Dy, Er, Fe, Gd, Hf, La, Nd, Ni, P, Pt, Pr, Sc, Y, Yb, and Zr.

9. The alloy as in claim 8, wherein said primary spheroids have an aspect ratio on the order of 0.9.

10. The alloy as in claim 8, comprising discontinuous eutectic domain boundaries.

11. The alloy as in claim 9, wherein said discontinuous eutectic domain boundaries comprise about 10⁻³ or less connecting lamellae/μm.
